(19) United States
(12) Patent Application Publication
(10) Pub. No.: US 2017/0174975 A1
(43) Pub. Date: Jun. 22, 2017

(54) EMULSIFIERS FOR WELLBORE STRENGTHENING

(71) Applicant: M-I L.L.C., Houston, TX (US)

(72) Inventors: Guido De Stefano, Spring, TX (US); Steven Young, Cypress, TX (US); Brandi Katherine Price Hoelscher, Houston, TX (US)

(73) Assignee: M-I L.L.C., Houston, TX (US)

(21) Appl. No.: 15/388,143

(22) Filed: Dec. 22, 2016

Related U.S. Application Data
(60) Provisional application No. 62/270,665, filed on Dec. 22, 2015.

(51) Int. Cl. C09K 8/36; E21B 33/138; E21B 21/00

(52) U.S. Cl. CPC C09K 8/36; E21B 21/003; E21B 33/138

(57) ABSTRACT

Methods may include drilling at least a section of a wellbore using an invert emulsion wellbore fluid, where the invert emulsion wellbore fluid may contain an emulsifier, a first wellbore strengthening material (WBS)-forming component, and a second WBS-forming component; and increasing the shear experienced at the bit.

### CROSS REFERENCE TO RELATED APPLICATIONS

This application claims the benefit of U.S. Provisional Application No. 62/270,665 filed on Dec. 22, 2015, incorporated by reference herein in its entirety.

### BACKGROUND

During the drilling of a wellbore, various fluids may be used in the well for a variety of functions. The fluids may be circulated through a drill pipe and drill bit into the wellbore, and then may subsequently flow upward through the wellbore to the surface. During this circulation, the drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the formation by providing sufficient hydrostatic pressure to prevent the ingress of formation fluids into the wellbore, to cool and lubricate the drill string and bit, and/or to maximize penetration rate.

Wellbore fluids may also be used to provide sufficient hydrostatic pressure in the well to prevent the influx and efflux of formation fluids and wellbore fluids, respectively. When the pore pressure (the pressure in the formation pore space provided by the formation fluids) exceeds the pressure in the open wellbore, the formation fluids tend to flow from the formation into the open wellbore. Therefore, the pressure in the open wellbore is often maintained at a higher pressure than the pore pressure. However, when wellbore pressures are maintained above the pore pressure, the pressure exerted by the wellbore fluids may exceed the fracture resistance of the formation and fractures and induced mud losses may occur. Further, formation fractures may result in the loss of wellbore fluid that decreases the hydrostatic pressure in the wellbore to decrease, which may in turn also allow formation fluids to enter the wellbore. As a result, the formation fracture pressure may define an upper limit for allowable wellbore pressure in an open wellbore while the pore pressure defines a lower limit. Therefore, one constraint on well design and selection of drilling fluids is the balance between varying pore pressures and formation fracture pressures or fracture gradients though the depth of the well.

As stated above, wellbore fluids are circulated downhole to remove rock, as well as deliver agents to combat the variety of issues described above. Fluid compositions may be water- or oil-based and may contain weighting agents, surfactants, proppants, viscosifiers, and fluid loss additives. However, fluid loss may impede wellbore operations, as fluids escape into the surrounding formation. During drilling operations, variations in formation composition may lead to undesirable fluid loss events in which substantial amounts of wellbore fluid are lost to the formation through large or small fissures or fractures in the formation or through a highly porous rock matrix surrounding the borehole. While fluid loss is often associated with drilling applications, other fluids may experience fluid loss into the formation including wellbore fluids used in completions, drill-in operations, productions, etc. Lost circulation may occur naturally in formations that are fractured, highly permeable, porous, cavernous, or vugular.

Lost circulation may also result from induced pressure during drilling. Specifically, induced mud losses may occur when the mud weight, which is often tuned for well control to maintain a stable wellbore, exceeds the fracture resistance of the formations. A particularly challenging situation arises in depleted reservoirs, in which the drop in pore pressure effectively weakens a wellbore through permeable, potentially hydrocarbon-bearing rock formation, but neighboring or inter-bedded low permeability rocks maintain their pore pressure. This can make the drilling of certain depleted zones impossible because the mud weight employed to support lower permeability rocks such as shale may exceed the fracture resistance of high permeability sands and silts. Another unintentional method by which lost circulation can result is through the inability to remove low and high gravity solids from fluids. Without being able to remove such solids, the fluid density can increase, thereby increasing the hole pressure, and if such hole pressure exceeds the formation fracture pressure, fractures and fluid loss can result.

Various methods have been used to restore circulation of a drilling fluid when a lost circulation event has occurred, particularly the use of “lost circulation materials” (LCM) that seal or block further loss of circulation. These materials may generally be classified into several categories: surface plugging, interstitial bridging, and/or combinations thereof. In addition to traditional LCM pills, crosslinkable or absorbing polymers, and cement or gunk squeezes have also been employed to combat fluid loss downhole.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, methods in accordance with the present disclosure may include drilling at least a section of a wellbore using an invert emulsion wellbore fluid, where the invert emulsion wellbore fluid may contain an emulsifier, a first wellbore strengthening material (WBS)-forming component, and a second WBS-forming component; and increasing the shear experienced at the bit.

In another aspect, embodiments of the present disclosure are directed to invert emulsion fluid systems that may contain a continuous phase and a discontinuous phase, where the continuous phase may include a first base fluid and a first WBS-forming component, and the discontinuous phase may include a second base fluid and a second WBS-forming component. The second WBS-forming component is capable of reacting with the first WBS-forming component to form a WBS upon breaking the invert emulsion.

Other aspects and advantages of the invention will be apparent from the following description and the appended claims.

### BRIEF DESCRIPTION OF DRAWINGS

FIG. 1 shows an image of the result of shearing the fluid of Example 1 with a Silverson mixer at 7000 rpm for 5 minutes.

FIG. 2 shows an image of the result of shearing the fluid of Example 2 with a Silverson mixer at 7000 rpm for 5 minutes.

FIG. 3-5 are charts that illustrate the results of shearing emulsified fluids with a Silverson mixer at 7000 rpm for 1 minute.

### DETAILED DESCRIPTION

Embodiments disclosed herein relate to methods of treating a formation such as by strengthening or treating fluid loss in downhole formations. Methods and chemical systems in accordance with the present disclosure are directed to strengthening and/or stabilizing a formation, wherein a multi-component system capable of reacting to form a wellbore strengthening material (WBS) is employed. In one or more embodiments described herein, WBS-forming components that react to form a WBS material may be combined to form a WBS on demand, such as when fluid loss is experienced during a wellbore operation. In one or more embodiments, WBS-forming components may be isolated in separate phases of a single fluid.

Embodiments of the present disclosure may be particularly suitable for drilling through depleted sandstone formations, as well as other depleted formation types. Depleted formations pose numerous technical challenges, including wellbore instability, severe lost circulation, etc., which generally make further development uneconomical. Uncontrollable drilling fluid losses frequently are unavoidable in the often large fracture characteristics of these formations. While conventional wellbore strengthening techniques often involve the use of particulates to create a hoop stress and thus increase the strength of the formation through formation of a stress cage, such techniques involve the formation of new fractures, which may be undesirable for a depleted formation. Thus, embodiments of the present disclosure seek to strengthen the formation through the multi-component system capable of reacting to form wellbore strengthening materials in situ. The chemical reaction of the fluid components may be selectively activated as the fluid leaves the drill bit at the bottom of the wellbore to prevent or at least reduce premature reaction within the drill string and also to achieve reaction in the near-bit area, when desired. Thus, to achieve such selective activation, multiple components may be incorporated into the wellbore fluid. To avoid or reduce premature reaction, both of the components may be rendered chemically non-reactive, by separation from each other through use of an emulsion. Upon activation and exposure to each other, the two (or more) components may react to form the wellbore strengthening material.

In one or more embodiments, a first WBS-forming component may be provided in a first phase of a wellbore fluid, while a second WBS-forming component may be provided in a second phase of a wellbore fluid. In some embodiments, the wellbore fluid may be an invert or direct emulsion fluid and the first phase may be a continuous phase, while the second phase may be a discontinuous phase or vice-versa. In one or more embodiments, the wellbore fluids may be formulation to be more unstable (kinetically and/or thermodynamically) than conventional complete emulsions. The emulsion may be broken by shear, for example, whereas a conventional complete emulsion would not break under shear conditions experienced downtown. However, in one or more embodiments, the emulsion may have enough stability to undergo some shear (such as the shear experienced when traveling through a pump used to pump the wellbore fluid downhole) but not stable enough to survive a greater amount of shear. At a minimum, the emulsion should remain stable at least above 10,000 s⁻¹, but may begin to break at higher levels of shear. In some embodiments the emulsion may begin to break above 15,000 s⁻¹, and in other embodiments the emulsion may begin to break above 20,000 s⁻¹. In one or more embodiments, a wellbore fluid according to these conditions may be used downhole during normal wellbore operations and, upon experiencing fluid loss into the formation, an increase in shear force may be used to cause the two phases to mix, thereby exposing the first and second WBS-forming components to each other, resulting in the formation of a wellbore strengthening material.

In one or more embodiments, the wellbore strengthening material may be a lost circulation material that seals or otherwise impedes the flow of wellbore fluids into intervals of the wellbore experiencing fluid loss. In such embodiments, the lost circulation material may bridge or fill pores or fractures in the formation, thereby reducing or curing the flow of wellbore fluids into the formation.

In other embodiments, the wellbore strengthening material may seek to strengthen the formation through the formation of a chemical sealing layer at or in the filter cake. Such embodiments may be distinguished from a conventional filter cake in that the chemical sealing layer provides greater strength and stability to the filter cake as compared to a filter cake formed from simple drilling fluid leak-off. While a conventional filter cake may include polymeric and solid components therein to bridge pore throats and/or provide filtration reduction, the present embodiments are directed to a filter cake in which a chemical reaction, such as polymerization or crosslinking, occurs to change the chemical nature of the filter cake in situ. Further, in one or more embodiments, in situ refers to simultaneous with or following the formation of a filter cake. The chemical reaction of the fluid components may be selectively activated to prevent or at least reduce premature reaction within the drill string and also to achieve reaction in the near-bit area, when desired. Thus, to achieve such selective activation, multiple components may be incorporated into the wellbore fluid(s). To avoid or reduce premature reaction, one of the components may be encapsulated or otherwise rendered chemically non-reactive. Upon activation and exposure to a second component, with which the first component is reactive, the two (or more) components may react and change the chemical nature of a filter cake and form a chemical sealing layer. In such embodiments, the reaction between the first and second components is sufficiently delayed that the fluid is able to filter into the formation to form a filter cake before substantial levels of reaction have occurred.

Further, in yet other embodiments, the WBS-forming components may filter into the formation (i.e., as a filtrate) during the formation of a filtercake to form a chemical seal within the near-wellbore formation region containing the filtrate while drilling in a wellbore. Such embodiments may be distinguished from conventional methods strengthening a wellbore in that the chemical sealing layer provides greater strength and stability to the near-wellbore formation region containing the filtrate as compared to the filter cake provided by the components of the drilling fluid from simple drilling fluid leak-off.

The present embodiments are directed to providing components within the filtrate in which a chemical reaction, such as polymerization or crosslinking, or viscosity change occurs in situ to change the chemical nature of the near-wellbore formation region containing the filtrate. Further, in one or more embodiments, in situ refers to simultaneous with or following the filtration of the drilling fluid into the drilled formation. The chemical reaction of the fluid components may be selectively activated to prevent or at least reduce premature reaction within the drill string and also achieve reaction in the near-bit area, when desired. Thus, to achieve such selective activation, in one or more embodiments multiple components may be incorporated into the wellbore fluid(s). To avoid or reduce premature reaction, one of the components may be encapsulated or otherwise rendered chemically non-reactive. Upon activation and exposure to a second sealing component, with which the first sealing component is reactive, the two (or more) components may react and change the chemical nature of the formation region containing the filtrate and form a chemical sealing layer behind the filter cake. The reaction between the first and second components may be sufficiently delayed so that the fluid is able to filter into the formation as a filtrate before substantial levels of reaction have occurred.

In each of these embodiments, the increase in shear may be enough to break an emulsified wellbore fluid that initially has the first and second WBS-forming components in two separate phases, thereby initiating their intimate mixing and reaction to form an wellbore strengthening material in situ that serves to strengthen the formation, reduce fluid loss, etc. The wellbore strengthening material may be formed in or may otherwise enter into sites of fluid loss including, for example, fractures, vugs, and highly permeable zones, and reduces fluid loss. Further, because the wellbore strengthening material is formed at the site of injection when delivered from a drill bit and/or drill string and shear is increased, the use of wellbore fluid components and damage to the formation from excess wellbore strengthening material may be minimized. During drilling operations using methods in accordance with the present disclosure, any excess wellbore strengthening material formed may be recovered from returned wellbore fluids and drill cuttings and removed by techniques known in the art, such as mechanical shakers and other separation methods. As fluid loss is reduced and fluid pressures return to suitable levels for drilling, the increase in shear force to initiate the two WBS-forming component mixing may be stopped and drilling operations may resume.

In one or more embodiments, the increase in force rate necessary to intermix the two WBS-forming components to form the wellbore strengthening material may be created in the near bit area as the wellbore fluid exits the drill string by dedicated nozzles engineered onto the drill bit or drill string. For example, a wellbore fluid according to the present disclosure may be used downhole during normal wellbore operations and, upon experiencing fluid loss into the formation, the dedicated nozzles may be activated to increase the shear rate causing the two phases to mix, thereby exposing the first and second WBS-forming components to each other, resulting in the formation of a wellbore strengthening material that strengthens the formation and/or seals or otherwise impedes the flow of wellbore fluids into intervals of the wellbore experiencing fluid loss. For example, depending on the shear forces needed to break the emulsion, the nozzle design may incorporate multiple chambers to allow for creation of additional shear as the fluid exits the bit. Such high energy hydraulics are described, for example, in U.S. Pat. No. 5,495,903, which is incorporated herein by reference in its entirety.

In general, shear forces are closely related to the pressure drop experienced by a wellbore fluid passing through constrictions in various pumps, nozzles, pipes, and drill-bits that may be present during a particular wellbore operation. This phenomenon is also known as the Venturi effect, which describes the physical process in which a fluid's velocity increases as it passes through a constriction to satisfy the principle of continuity, while its pressure decreases to satisfy the principle of conservation of mechanical energy. The greater the pressure differential between two particular stages that a wellbore fluid passes through (e.g., a change in diameter of a length of pipe or tubing), the greater the proportional pressure drop and shear force the fluid experiences. For example, shear forces may be highest when a fluid passes through narrow openings or nozzles on a drill bit or a port of completion string downhole. Thus, the dedicated nozzles on the drill bit or drill string may be designed to produce the highest shear forces that the wellbore fluid of the present disclosure will experience so as to prevent the LCM from forming at a location other than substantially where the wellbore fluid exits the drill bit.

In one or more embodiments, the wellbore fluid may be designed such that the two phases, each containing a WBS-forming component, intermix when exposed to shear forces that may range from 10,000 to 50,000 s⁻¹ in some embodiments, or from 12,000 to 30,000 s⁻¹ In other embodiments, intermixing of the two WBS-forming components may occur at shear forces of at least 20,000 s⁻¹ or at shear forces of least 30,000 s⁻¹ in yet other embodiments.

In one or more embodiments, a wellbore fluid having a first WBS-forming component provided in a first phase of the wellbore fluid and a second WBS-forming component provided in a second phase of a wellbore fluid may be injected as needed as a fluid loss pill. As used herein, the term “pill” is used to refer to a relatively small quantity (often around 200 bbl or less) of a special blend of wellbore fluid to accomplish a specific task that the regular wellbore fluid cannot perform. In some embodiments, the pill may be used to plug a “thief zone,” which simply refers to a formation into which circulating fluids can be lost. For example, operators on a rig may notice a decrease or cessation in the flow of fluid returning and a volume of a wellbore fluid having a first WBS-forming component provided in a first phase of the wellbore fluid and a second WBS-forming component provided in a second phase of a wellbore fluid may be prepared and pumped downhole to produce, in concurrence with an increased shear force, a wellbore strengthening material that may plug the zone where fluid is being lost. In some embodiments, the volume of the second wellbore fluid applied as a pill may range from 1 to 30 m³, from 3 to 20 m³, or from 5 to 16 m³.

Wellbore Fluid Formulation with WBS-Forming Components

In one or more embodiments, the wellbore fluid may be an invert emulsion with an oleaginous continuous phase and an aqueous (or non-oleaginous liquid) discontinuous phase, among other substances and additives, or a direct emulsion having an aqueous continuous phase and oleaginous discontinuous phase. Suitable oil-based or oleaginous fluids may be a natural or synthetic oil and in some embodiments, in some embodiments the oleaginous fluid may be selected from the group including diesel oil; mineral oil; a synthetic oil, such as hydrogenated and unhydrogenated olefins including polyalpha olefins, linear and branch olefins and the like, polydiorganosiloxanes, siloxanes, or organosiloxanes, esters of fatty acids, specifically straight chain, branched and cyclical alkyl ethers of fatty acids, mixtures thereof and similar compounds known to one of skill in the art; and mixtures thereof.

Aqueous or non-oleaginous liquids may, in some embodiments, include at least one of fresh water, sea water, brine, mixtures of water and water-soluble organic compounds, and mixtures thereof. In various embodiments, the non-oleaginous fluid may be a brine, which may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, and lithium salts of chlorides, bromides, carbonates, iodides, chlorates, bromates, formates, nitrates, oxides, sulfates, silicates, phosphates and fluorides. Salts that may be incorporated in a brine include any one or more of those present in natural seawater or any other organic or inorganic dissolved salts. Additionally, brines that may be used in the drilling fluids disclosed herein may be natural or synthetic, with synthetic brines tending to be much simpler in constitution. In one embodiment, the density of the drilling fluid may be controlled by increasing the salt concentration in the brine (up to saturation). In a particular embodiment, a brine may include halide or carboxylate salts of mono- or divalent cations of metals, such as cesium, potassium, calcium, zinc, and/or sodium.

The amount of oleaginous liquid in the invert emulsion fluid may vary depending upon the particular oleaginous fluid used, the particular non-oleaginous fluid used, and the particular application in which the invert emulsion fluid is to be employed. However, in some embodiments, the amount of oleaginous liquid may be sufficient to form a stable emulsion when used as the continuous phase. In some embodiments, the amount of oleaginous liquid may be at least about 30, or at least about 40, or at least about 50 percent by volume of the total fluid. The amount of non-oleaginous liquid in the invert emulsion fluid may vary depending upon the particular non-oleaginous fluid used and the particular application in which the invert emulsion fluid is to be employed. In some embodiments, the amount of non-oleaginous liquid may be at least about 1 percent by volume of the total fluid, or at least about 3 percent, or at least about 5 percent. In some embodiments, the amount may not be so great that it cannot be dispersed in the oleaginous phase. Therefore, in certain embodiments, the amount of non-oleaginous liquid may be less than about 90, or less than about 80, or less than about 70 percent by volume of the total fluid.

While, conventional methods can be used to prepare the invert emulsion drilling fluids disclosed herein, the first WBS-forming component may be added to one phase (oleaginous or non-oleaginous) and the second WBS-forming component to a second phase (oleaginous or non-oleaginous) prior to mixing the first and second phase to form the invert or direct emulsion fluid. For example, an invert emulsion may be formed by first adding a first WBS-forming component to an oleaginous fluid, adding a second WBS-forming component to a non-oleaginous fluid, and then vigorously agitating, mixing or shearing the oleaginous fluid and the non-oleaginous fluid at a shear rate sufficiently low to preclude breaking the two phases, which could lead to premature wellbore strengthening material formation. Thus, in the initially formulated wellbore fluid, the WBS-forming components are separated from each other by being stabilized within their own discrete phase.

WBS-Forming Components

In one or more embodiments, the multi-component WBS system may form silicate polymers from the reaction of a silicate with an alcohol, polyol, amine, or polyamine. As described above, in some embodiments, a wellbore fluid may be formulated with either the silicate or the alcohol/amine added to the oleaginous or non-oleaginous phases prior to their mixing to form the formulated invert emulsion wellbore fluid that upon experiencing high shear forces may break causing the two components to intermix and create wellbore strengthening materials on demand and as needed to strengthen the formation and/or combat fluid loss.

While not bound by a particular theory, it is believed that the combination of the silicate species and the alcohol or amine due to the breaking of the wellbore fluid initiates a series of hydrolysis and condensation reactions that serve to generally increase the molecular weight of the silicate species and in some instances crosslink the silicate monomeric units. The increase in molecular weight and crosslinking of the silicate species serves to generate a viscous gel which may form a more robust chemical seal in the filter cake/formation where the fluid loss is occurring.

A WBS-forming silicate component in accordance with the present disclosure may be present within the oleaginous or non-oleaginous phase of a wellbore fluid as a liquid or solid. For example, silicates may be selected from one or more of sodium silicate, potassium silicate, lithium silicate, quaternary ammonium silicates, and the like.

In one or more embodiments, a silicate may be combined with a small molecule or polymer having one or more hydroxyl groups in order to produce a wellbore strengthening material. For example, a wellbore strengthening material may be prepared from the reaction of a silicate and a hydroxyl-containing compound such as ethanol, propanol, glycerin, or a polyol containing 2 to 8 carbon atoms, including ethylene glycol, 1,2-propylene glycol, 1,3-propylene glycol, 1,4-butylene glycol, 1,5-pentanediol, 1,7-heptanediol, and the like. Other potential alcohols included are polyoxyalkylene glycols and water-soluble mono-alkyl ethers of glycols and polyoxyalkylene glycols, polyoxyalkylene glycols such as polyoxyethylene glycols and polyoxypropylene glycols, monoalkyl ethers of glycols include monomethyl ether of ethylene glycol, monoethyl ether of ethylene glycol, monobutyl ether of ethylene glycol, mono-methyl ether of propyleneglycol, monobutyl ether of propylene glycol, monomethyl ether of diethylene glycol, mono-ethyl ether of diethylene glycol, monobutyl ether of diethylene glycol and the like.

Suitable hydroxyl-containing polymers also include saccharides such as xanthan gum, guar gum, carboxymethylated polysaccharides, hydroxypropyl polysaccharides, carboxymethyl, hydroxypropyl polysaccharides, and similarly derivatized starches. Other examples include guar gum, cellulose, arabic gum, guar gum, locust bean gum, tara gum, cassia gum, agar, alginates, carrageenans, chitosan, scleroglucan, diutan, or modified starches such as n-octenyl succinated starch, porous starch, and hydroxypropyl- and/or carboxymethyl-derivatives of any of the above. Other suitable hydroxyl-containing polymers may be selected from synthetic polymers such as polyvinyl alcohol, partially hydrolyzed polyvinyl acetate, and copolymers containing vinyl alcohol or other monomers containing hydroxyl-substituted side chains. Further, suitable crosslinkable polymers may be branched or linear polyols with available hydroxy and/or amino groups.

Suitable amines may include small molecules and polymers capable of reacting with a silicate to form a wellbore strengthening material such as, for example: methylamine, ethylamine, propylamine, isopropylamine, butylamine, amylamine, hexylamine aniline, toluidine amine, xylidine amine, naphthylamine, benzylamine, di- and polyamines such as C₆-C₁₂ diamines, phenylenediamine, ethylenediamine, tetramethylenediamine, pentamethylenediamine, hexamethylenediamine, octamethylenediamine, decamethylenediamine, xylylenediamine, diphenylamine, piperazine and other compounds such as aminocaproic acid, polyamines, alkylene polyamines, vinyl amines, diethylenetriamine, triethylenetetramine, tetraethylenepentamine, and the like. Other possible components include species that contain heterogeneous functional groups such as aminoacetaldehyde diethyl acetal, aminoacetic acid, aminobenzoic acid, 2-amino-1-butanol, 2-aminoethanol, 1-amino-2-propanol, O-aminophenol, p-aminophenol, 1-amine-2-propanol, 6-amino-2-picoline, 2-amino-4-nitrophenol, aminosuccinic acid (DL Aspartic acid), 2-aminopyridine, and mixtures thereof. In one or more embodiments, suitable amino-containing components may include polyetheramides such as the series of Jeffamines® available from Huntsman Corporation (Dayton, Tex.).

In other embodiments, silicates may also be reacted with multivalent cations (e.g., Ca⁺², Mg⁺², Al⁺³, Fe⁺³, etc.) to produce insoluble metal silicates or metal silicate gels. For example, upon contact with divalent calcium ions, a monovalent silicate may react with the calcium to form a hydrated calcium silicate. Multivalent cations may be derived from the corresponding salts such as bicarbonates, phosphates, polyphosphates, sulfates, etc. Such inorganic setting agents may be included in the external phase of the fluid (or in a second emulsion) so that, during emplacement of a fluid in a wellbore, the setting agent is kept separate from silicate internal phase to avoid premature crosslinking of the silicates and setting of the fluid.

In other embodiments, the corresponding component that initiates wellbore strengthening material formation with a silicate may be an inorganic salt such as calcium chloride (CaCl₂), aluminum sulfate (Al₂(SO₄)₃), or strontium chloride (SrCl₂). When the WBS-forming component is an inorganic salt, the reaction with the sodium or potassium silicate first component will result in precipitation of a calcium, aluminum, or strontium silicate wellbore strengthening material, respectively, which may then treat formation defects that are the source of fluid loss.

In one or more embodiments, the multi-component WBS system may form a polymeric wellbore strengthening material from the reaction of a first component such as an alcohol, polyol, amine, polyamine with a second component capable of crosslinking the first component. In one or more embodiments, a wellbore strengthening material may be produced from the reaction of a polymer having hydroxyl or amine functional groups and an ionic crosslinker such as borate, zirconium, titanium, aluminum, Group IVB elements, and other polyvalent ions. Ionic crosslinks are reversible crosslinks that form as polyvalent ions coordinate with multiple functional groups present on a single molecule or polymer chain, or between neighboring molecules or polymer chains. For example, in some embodiments borates may be used to crosslink a second component having compatible functional groups such as a small molecule or polymer having hydroxy or amino groups. Such crosslinked wellbore strengthening materials may be described as self-healing because crosslinks may be reformed if broken by reforming a crosslink at the same site or a neighboring site of the same or different polymer.

In one or more embodiments, a wellbore strengthening material may be formed from a source of ionic crosslinker such as a borate salt and a water-soluble hydroxyl-containing polymer. As described above, in some embodiments, a wellbore fluid may be formulated with either the water-soluble hydroxyl-containing polymer or the borate salt added to the oleaginous or non-oleaginous phases prior to mixing the oleaginous and non-oleaginous phases to form the formulated invert emulsion wellbore fluid. The formulated invert emulsion wellbore fluid, upon experiencing high shear forces, may break causing the two components to intermix and create wellbore strengthening material on demand and as needed to combat fluid loss. Wellbore strengthening materials formed in accordance with the present disclosure may be employed as a relatively impermeable barrier cordoning off fluid loss zones during wellbore operations such as drilling or used to isolate a production zone from an area undergoing a workover operation.

Polyvalent ions may be added as a solution, slurry, or as a solid. Sources of borate may include borax, sodium pentaborate, sodium tetraborate, and boric acid. Other non-limiting sources of polyvalent ions may include zirconium from zirconium lactate ammonium zirconium carbonate, potassium zirconium carbonate; titanium from, for example, titanium tetrachloride, titanium tetrabromide, tetra amino titanate, titanium acetylacetonate, triethanolamine titanate, titanium lactate, n-butyl polytitanate, titanium tetrapropanolate, octyleneglycol titanate, tetra-n-butyl titanate, tetra-n-buytl titanate, tetra-2-ethylhexyl titanate, tetra-isopropyl titanate tetra-isopropyl titanate, diisopropyl di-triethanolamino titanate, titanium ortho ester, titanium (IV) chloride, and mixtures thereof; and other available salts of magnesium, calcium, aluminum, chromium, and other Group IVB elements capable of complexing with polysaccharides to form a polymeric wellbore strengthening material.

In one or more embodiments, a polyvalent ion crosslinking agent may be used to crosslink a small molecule or polymer having one or more hydroxyl groups including, for example, diols containing 2 to 8 carbon atoms, such as ethylene glycol, 1,2-propylene glycol, 1,3-propylene glycol, 1,4-butylene glycol, 1,5-pentanediol, 1,7-heptanediol, and the like. Other polyols may include small molecules having multiple hydroxyl groups such as glycerol, sugar alcohols, etc. Other suitable hydroxyl-containing molecules may include polyvinyl acetate, polyoxyalkylene glycols and water-soluble mono-alkyl ethers of glycols and polyoxyalkylene glycols, polyoxyalkylene glycols such as polyoxyethylene glycols and polyoxypropylene glycols, monoalkyl ethers of glycols include monomethyl ether of ethylene glycol, monoethyl ether of ethylene glycol, monobutyl ether of ethylene glycol, mono-methyl ether of propyleneglycol, monobutyl ether of propy-lene glycol, monomethyl ether of diethylene glycol, mono-ethyl ether of diethylene glycol, monobutyl ether of diethylene glycol and the like.

Suitable hydroxyl-containing polymers also include saccharides such as xanthan gum, guar gum, carboxymethylated polysaccharides, hydroxypropyl polysaccharides, carboxymethyl, hydroxyproply polysaccharides, and similarly derivatized starches. Other examples include guar gum, cellulose, arabic gum, guar gum, locust bean gum, tara gum, cassia gum, agar, alginates, carrageenans, chitosan, scleroglucan, diutan, or modified starches such as n-octenyl succinated starch, porous starch, and hydroxypropyl- and/or carboxymethyl-derivatives of any of the above. Other suitable hydroxyl-containing polymers may be selected from synthetic polymers such as polyvinyl alcohol, partially hydrolyzed polyvinyl acetate, and copolymers containing vinyl alcohol or hydroxyl-substituted side chains. Further, suitable crosslinkable polymers may be branched or linear polyols with available hydroxy and/or amino groups.

Suitable amines may include small molecules and polymers capable of crosslinking to form an wellbore strengthening material such as, for example: methylamine, ethylamine, propylamine, isopropylamine, butylamine, amylamine, hexylamine aniline, toluidine amine, xylidine amine, naphthylamine, benzylamine, di- and polyamines such as C₆-C₁₂ diamines, phenylenediamine, ethylenediamine, tetramethylenediamine, pentamethylenediamine, hexamethylenediamine, octamethylenediamine, decamethylenediamine, xylylenediamine, diphenylamine, piperazine and other compounds such as aminocaproic acid, polyamines, alkylene polyamines, vinyl amines, diethylenetriamine, triethylenetetramine, tetraethylenepentamine, and the like. Other possible components include species that contain heterogeneous functional groups such as aminoacetaldehyde diethyl acetal, aminoacetic acid, aminobenzoic acid, 2-amino-1-butanol, 2-aminoethanol, l-amino-2-propanol, O-aminophenol, p-aminophenol, 1-amine-2-propanol, 6-amino-2-picoline, 2-amino-4-nitrophenol, aminosuccinic acid (DL Aspartic acid), 2-aminopyridine, and mixtures thereof. In one or more embodiments, suitable amino-containing components may include polyetheramines such as the series of Jeffamines® available from Huntsman Corporation (Dayton, Tex.). In other embodiments, small molecules or polymers containing carboxylic acid or phosphonate groups may be crosslinked with a polyvalent ion such as magnesium or calcium.

In one or more embodiments, the multi-component WBS-forming system may produce wellbore strengthening materials from the reaction of a small molecule or polymer having one or more reactive functional groups that are covalently crosslinked with a crosslinking component to form a polymeric wellbore strengthening material such as nylon, polyurethane, or polyisocyanate. For example, diisocyanates, glycidyl ethers, polyglycidyl ethers, branched or unbranched diacid chlorides such as adipoyl chloride may be combined with one or more of alcohols, polyols, amines, or polyamines to produce covalently crosslinked wellbore strengthening materials that may be substantially more rigid than those wellbore strengthening materials produced by ionic crosslinking alone. As described above, in some embodiments, a wellbore fluid may be formulated with either the small molecule/polymer having one or more reactive functional groups or the crosslinking component added to the oleaginous or non-oleaginous phases prior to mixing the oleaginous and non-oleaginous phases to form the formulated invert emulsion wellbore fluid. The formulated invert emulsion wellbore fluid, upon experiencing high shear forces, may break causing the two components to intermix and create wellbore strengthening material on demand and as needed to combat fluid loss.

For multi-component systems that form covalently crosslinked wellbore strengthening material, components molecules with hydroxyl or amino functional groups may be selected from any of those listed above for the ionic crosslinked wellbore strengthening material.

Covalent crosslinkers in accordance with the instant disclosure may include a diisocyanate crosslinker that may react with a small molecule or polymer having one or more functional groups such as hydroxyl or amino groups respectively to produce a polyurethane or polyurea wellbore strengthening material. Examples of suitable diisocyanates include aromatic and fatty diisocyanates, such as 2,4-tolylene diisocyanate, 2,6-tolylene diisocyanate and mixtures of these, 4,4-diphenylmethane diisocyanate, xylylene diisocyanates, isophorone diisocyanate, 5,5-trimethylcyclohexyl isocyanate, 6-hexamethylene diisocyante, 2,2,4-trimethylhexamethylene diisocyanate, and the like. Of these diisocyanates, 2,4- and 2,6-isomer or a mixture of tolylene diisocyanates, isophorone diisocyanate and xylene diisocyanates can be particularly preferable.

In some embodiments, a diacid chloride may be used as the crosslinking component that reacts with a small molecule or polymer having one or more functional groups such as hydroxyl or amino groups to produce a nylon polymer wellbore strengthening material. Suitable diacid chlorides may include, for example, oxalyl chloride, malonyl chloride, succinyl chloride, glutaryl chloride, adipoyl chloride, pimeloylchloride, suberoyl chloride, azelaoyl chloride, sebacoyl chloride, isophthaloyl chloride, terephthaloyl chloride, and the like.

In other embodiments, a glycidyl ether or other epoxy-containing species may be selected as the component that crosslinks with a small molecule or polymer having one or more functional groups such as hydroxyl or amino groups to produce an epoxy-derivative wellbore strengthening material. Suitable epoxy-containing components may include, for example, glycidyl ethers and other di-epoxides such as glycerol diglycidyl ether, 1,4-butanediol diglycidyl ether, ethylene glycol diglycidyl ether, propylene glycol diglycidyl ether, butylene glycol diglycidyl ether, trimethylolpropane triglycidyl ether, sorbitol polyglycidyl ether, diglycidyl ether of neopentyl glycol, epoxidized 1,6-hexanediol, polyepoxide compounds such as a polyamine/polyepoxide resins, oxidized starches, or aziridine derivatives of any of the above epoxy-containing species.

Wellbore fluids capable of acting as lost circulation treatments in accordance with the present disclosure may employ a base fluid and WBS-forming components, weighting agents, natural or synthetic fibers, and/or bridging agents. In yet other embodiments, the fluids/pills may include a number of other additives known to those of ordinary skill in the art, such as wetting agents, organophilic clays, viscosifiers, surfactants, dispersants, interfacial tension reducers, pH buffers, mutual solvents, thinners, thinning agents and cleaning agents. The addition of such agents should be well known to one of ordinary skill in the art of formulating drilling fluids and muds.

The type and amount of emulsifier used in an invert emulsion fluid can significantly affect the strength of the emulsion and therefore, the selection of the emulsifier is an important consideration for fluids disclosed herein. Generally, emulsifiers that may be used in the fluids disclosed herein include, for example, fatty acids, soaps of fatty acids, fatty amines, amidoamines, polyamides, polyamines, oleate esters, such as sorbitan monoleate, sorbitan dioleate, imidazoline derivatives or alcohol derivatives and combinations or derivatives of the above. Additionally, lime or other alkaline materials may be added to conventional invert emulsion drilling fluids and muds to maintain a reserve of alkalinity. In one or more embodiments, the emulsifier should be present in the formulated fluid in an amount from about 1.5 to 15 ppb, or from about 3 to 12 ppb, or from about 6 to 9 ppb. The amount of emulsifier used may vary depending on if a strong emulsifier or a weak emulsifier is used. For example, a weak emulsifier may need to be used in a greater amount to maintain the emulsion during normal drilling operations (e.g., prior to the experience of fluid loss) so that the reactant present therein only react upon the increase in shear initiated after experiencing fluid loss.

In some embodiments, the invert emulsion may be a high internal phase ratio (HIPR) emulsion, wherein the aqueous or non-oleaginous fluid within the oleaginous fluid is present in a volume amount that is more than the non-oleaginous fluid. While a number of possible emulsifiers may be used, one exemplary class of emulsifiers is alkoxylated ether acids. In one or more embodiments, an alkoxylated ether acid is an alkoxylated fatty alcohol terminated with an carboxylic acid, represented by the following formula:

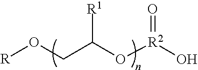

where R is C₆-C₂₄ or —C(O)R³ (where R³ is C₁₀-C₂₂), R¹ is H or C₁-C₄, R² is C₁-C₅ and n may range from 1 to 20. Such compounds may be formed by the reaction of an alcohol with a polyether (such as poly(ethylene oxide), poly(propylene oxide), poly(butylene oxide), or copolymers of ethylene oxide, propylene oxide, and/or butylene oxide) to form an alkoxylated alcohol. The alkoxylated alcohol may then be reacted with an α-halocarboxylic acid (such as chloroacetic acid, chloropropionic acid, etc.) to form the alkoxylated ether acid. In a particular embodiment, the selection of n may be based on the lipophilicity of the compound and the type of polyether used in the alkoxylation. In some particular embodiments, where R¹ is H (formed from reaction with poly(ethylene oxide)), n may be 2 to 10 (between 2 and 5 in some embodiments and between 2 and 4 in more particular embodiments). In other particular embodiments, where R¹ is —CH₃, n may range up to 20 (and up to 15 in other embodiments). Further, selection of R (or R³) and R² may also depend on based on the hydrophilicity of the compound due to the extent of polyetherification (i.e., number of n). In selecting each R (or R³), R¹, R², and n, the relative hydrophilicity and lipophilicity contributed by each selection may be considered so that the desired HLB value may be achieved. Further, while this emulsifier may be particularly suitable for use in creating a fluid having a greater than 50% non-oleaginous internal phase, embodiments of the present disclosure may also include invert emulsion fluids formed with such emulsifier at lower internal phase amounts.

Wetting agents that may be suitable for use in the fluids disclosed herein include crude tall oil, oxidized crude tall oil, surfactants, organic phosphate esters, modified imidazolines and amidoamines, alkyl aromatic sulfates and sulfonates, and the like, and combinations or derivatives of these. However, when used with the invert emulsion fluid, the use of fatty acid wetting agents should be minimized so as to not adversely affect the reversibility of the invert emulsion disclosed herein. FAZE-WET™, VERSACOAT™, SUREWET™, VERSAWET™, and VERSAWET™ NS are examples of commercially available wetting agents manufactured and distributed by M-I L.L.C. that may be used in the fluids disclosed herein. Silwet L-77, L-7001, L7605, and L-7622 are examples of commercially available surfactants and wetting agents manufactured and distributed by General Electric Company (Wilton, Conn.).

Organophilic clays, normally amine treated clays, may be useful as viscosifiers and/or emulsion stabilizers in the fluid composition disclosed herein. Other viscosifiers, such as oil soluble polymers, polyamide resins, polycarboxylic acids and soaps can also be used. The amount of viscosifier used in the composition can vary upon the end use of the composition. However, normally about 0.1% to 6% by weight range is sufficient for most applications. VG-69™ and VG-PLUS™ are organoclay materials distributed by M-I, L.L.C., Houston, Tex., and VERSA-HRP™ is a polyamide resin material manufactured and distributed by M-I, L.L.C., that may be used in the fluids disclosed herein. In some embodiments, the viscosity of the displacement fluids is sufficiently high such that the displacement fluid may act as its own displacement pill in a well.

Conventional suspending agents that may be used in the fluids disclosed herein include organophilic clays, amine treated clays, oil soluble polymers, polyamide resins, polycarboxylic acids, and soaps. The amount of conventional suspending agent used in the composition, if any, may vary depending upon the end use of the composition. However, normally about 0.1% to about 6% by weight is sufficient for most applications. VG-69™ and VG-PLUS™ are organoclay materials distributed by M-I L.L.C., and VERSA-HRP™ is a polyamide resin material manufactured and distributed by M-I L.L.C., that may be used in the fluids disclosed herein.

One skilled in the art would appreciate that depending on components present in the fluid, the pH of the fluid may change. In particular embodiments of the present disclosure, the pH of the treatment fluid may be less than about 10, and between about 7.5 and 8.5 in other embodiments. However, in other embodiments, a greater pH may be desired, and may be achieved by including an alkaline material such as lime to the pill.

In one or more embodiments, wellbore fluids in accordance with the present disclosure may include at least one fiber additive to aid in suspension and to provide additional compressive strength to the resulting plug or seal. However, other embodiments may use other wellbore strengthening materials, where the addition of the fiber may restore at least a portion of the strength loss due to the incorporation of a weighting agent. As used herein, the term “fiber” refers to an additive that has an elongated structure. The fiber may be inert with respect to the base fluid and the WBS-forming components.

Various embodiments of the present disclosure may use a fiber that has an elongated structure, which may be spun into filaments or used as a component of a composite material such as paper. In a particular embodiment, the fibers may range in length from greater than 3 mm to less than 20 mm. While some embodiments may use a synthetic fiber, other embodiments may include either a naturally occurring fibrous (such as cellulose) material, and/or a synthetic (such as polyethylene, or polypropylene) fibrous material.

Synthetic fibers may include, for example, polyester, acrylic, polyamide, polyolefins, polyaramid, polyurethane, vinyl polymers, glass fibers, carbon fibers, regenerated cellulose (rayon), and blends thereof. Vinyl polymers may include, for example, polyvinyl alcohol. Polyesters may include, for example, polyethylene terephthalate, polytriphenylene terephthalate, polybutylene terephthalate, polylatic acid, and combinations thereof. Polyamides may include, for example, nylon 6, nylon 6,6, and combinations thereof. Polyolefins may include, for example, propylene based homopolymers, copolymers, and multi-block interpolymers, and ethylene based homopolymers, copolymers, and multi-block interpolymers, and combinations thereof. The fiber may be added to the pill in an amount ranging from 0.5 ppb to 10 ppb in some embodiments; however, more or less may be desired depending on the particular application.

A natural fiber may optionally be used with the wellbore strengthening materials (including silicate particles or other wellbore strengthening materials) to aid in suspension and viscosification of the slurry, as well as provide additional compressive strength to the resulting plug or seal. As used herein, the term “natural fiber” refers to an additive formed from a naturally occurring material that has an elongated structure, which may be spun into filaments or used as a component of a composite material such as paper. Similar to the synthetic fiber described above, the natural fiber may be inert (does not react with) with respect to the base fluid and to the wellbore strengthening materials. When included, natural fibers may be present in an amount up to 50 percent by weight of the pill.

Natural fibers generally include vegetable fibers, wood fibers, animal fibers, and mineral fibers. In particular, the natural fibers include cellulose, a polysaccharide containing up to thousands of glucose units. Cellulose from wood pulp has typical chain lengths between 300 and 1700 units, whereas cotton and other plant fibers as well as bacterial celluloses have chain lengths ranging from 800 to 10,000 units. In other embodiments, cellulose fibers may be either virgin or recycled, extracted from a wide range of plant species such as cotton, straw, flax, wood, etc.

Further, as mentioned above, the fluids/pills of the present disclosure may optionally include at least one weighting agent to provide the desired weight to the fluids/pills. As is known in the art, control of density may be desired to balance pressures in the well and prevent a blowout. To prevent a blowout, the fluid in the well may have a density effective to provide a greater pressure than that exerted from the formation into the well. However, fluids having a density that place pressures on the formation that exceed the fracture strength of the formation may cause further lost circulation. Thus, it is often desirable to modify the density of a wellbore fluid with weighting agents to balance the pressure requirements of the well. Weighting agents may be selected from one or more of the materials including, for example, barium sulfate, calcium carbonate, dolomite, ilmenite, hematite or other iron ores, olivine, siderite, manganese oxide, and strontium sulfate. Additionally, it is also within the scope of the present disclosure that the fluid may also be weighted up using salts (either in a water- or oil-based pill) such as those described above with respect to brine types. Selection of a particular material may depend largely on the density of the material. The lowest wellbore fluid viscosity at any particular density is obtained by using the highest density particles. Weighting agents may be added to the pill in an amount such that the final density may range from 6.5 pounds per gallon (ppg) to 20 ppg in some embodiments.

In addition to the above materials within the scope of the present disclosure bridging agents may also be incorporated into a wellbore fluid. Particulate-based treatments may include use of particles frequently referred to in the art as bridging materials. For example, such bridging materials may include at least one substantially crush resistant particulate solid such that the bridging material props open and bridges or plugs the fractures (cracks and fissures) that are induced in the wall of the wellbore. As used herein, “crush resistant” refers to a bridging material is physically strong enough to resist the closure stresses exerted on the fracture bridge. Examples of bridging materials suitable for use in the present disclosure include graphite, calcium carbonate (such as marble), dolomite (MgCO₃.CaCO₃), celluloses, micas, proppant materials such as sands or ceramic particles and combinations thereof. Such particles may range in size from 25 microns to 1500 microns. Selection of size may depend on the level of fluid loss, the fracture width, the formation type, etc.

Application of WBS-forming components adjacent a permeable formation may be accomplished by methods known in the art. For example, “thief zones” or permeable intervals will often be at or near the bottom of the wellbore and will begin to absorb drilling fluids when exposed during drilling operations. In such situations, a WBS treatment may be spotted adjacent the permeable formation by pumping a slug or pill of the treatment down and out of the drill pipe or drill bit as is known in the art. It may be, however, that the permeable formation is at a point farther up in the wellbore, which may result, for example, from failure of a previous seal. In such cases, the drill pipe may be raised as is known in the art so that the pill or slug of the WBS treatment may be deposited adjacent the permeable formation. The volume of the slug of WBS treatment that is spotted adjacent the permeable formation may range from less than that of the open hole to more than double that of the open hole.

In some instances, more than one sequence of the described fluid system treatments may be applied to produce sufficient WBS material to treat a given interval experiencing fluid loss. Such need may arise when a first treatment is insufficient to plug the fissures and thief zone or was placed incorrectly. Further, in some instances, the first round of treatment may have sufficiently plugged the first lost circulation zone, but a second (or more) lost circulation zone may also exist that warrants further treatment.

It is also within the scope of the present disclosure that one or more spacer pills may be used in conjunction with the pills of the present disclosure. A spacer is generally characterized as a thickened composition that functions primarily as a fluid piston in displacing fluids present in the wellbore and/or separating two fluids from each other.

Embodiments of the present disclosure may provide for a lost circulation fluid that may be useful in high and low fluid loss zones. Use of the fluid systems of the present disclosure may allow for the formation of a plug or seal of a permeable formation that has a high compressive strength, which allows for greater pressures to be used without risk of experiencing further losses to the sealed lost circulation zone.

Each WBS-forming component may be added to the wellbore fluid in an amount ranging from 0.5 ppb to 80 ppb in some embodiments; however, more or less may be desired depending on the particular application. The amount of WBS-forming components employed may depend on the fluid loss levels, the anticipated fractures, the density limits for the pill in a given wellbore and/or pumping limitations, etc.

### EXAMPLES

### Examples 1-2

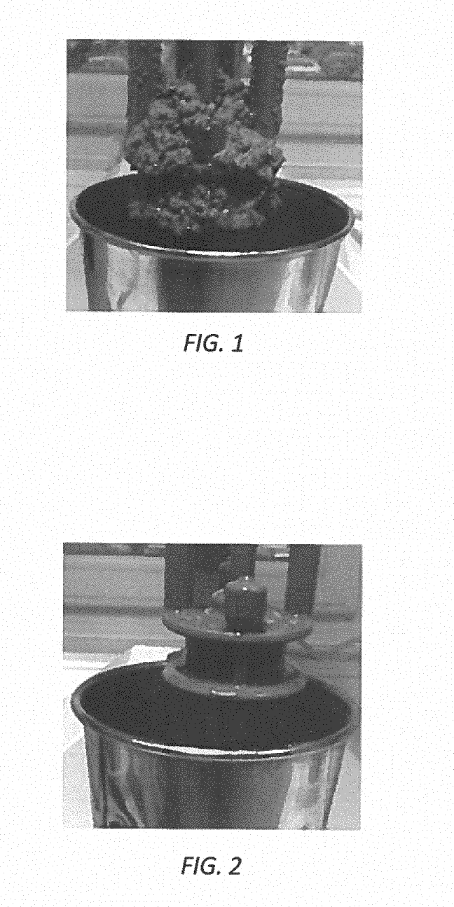

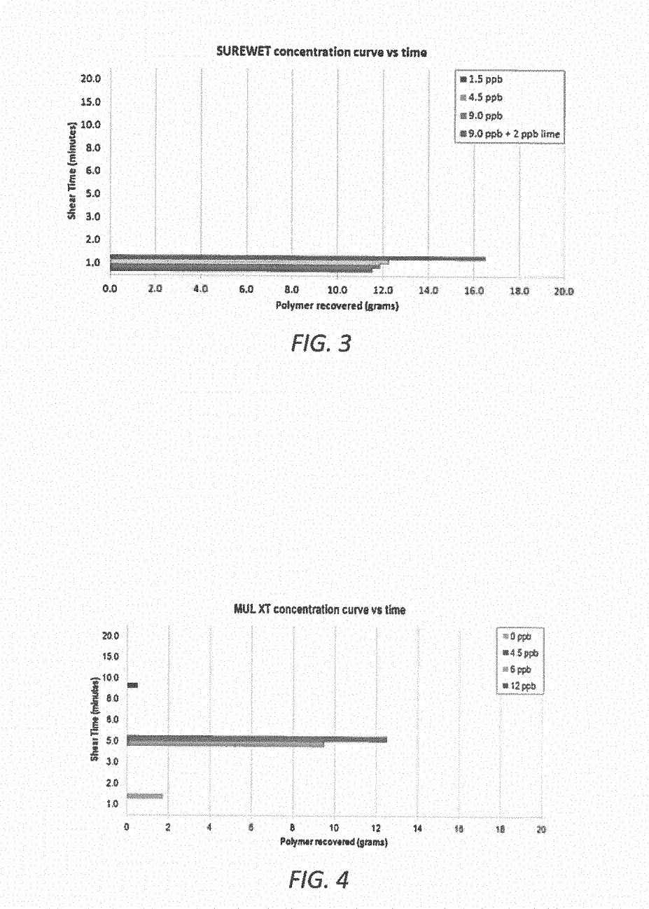

To illustrate the concept of the present disclosure, two invert emulsion wellbore fluids were formulated with glycerol (component 1) mixed with the brine phase, while the silicate (component 2), a sodium metasilicate, was mixed with the oleaginous phase prior to mixing the phases to form the emulsion. The wellbore fluid of Example 1 had a low emulsifier concentration when compared to the wellbore fluid of Example 2. Thus, the fluid of Example 1 was a weaker emulsion and was easier to break in order to form a LCM. To simulate each fluid's possible performance downhole, a Silverson mixer was utilized to shear each fluid. FIG. 1 shows an image of the result of shearing the fluid of Example 1 with a Silverson mixer at 7000 rpm for 5 minutes, while FIG. 2 shows an image of the result of shearing the fluid of Example 2 under the same conditions. The material shown on the rotor/stator workhead in FIG. 1 is the polymeric material that forms as a result of the emulsion breaking under the shear experienced. In the fluid of Example 2, due to the higher concentration of emulsifier, the emulsion is strong enough to resist breaking and therefore no polymer is formed by the reaction of the glycerol with the silicate species because each component remain effectively separated in the biphasic system.

### Examples 3-13

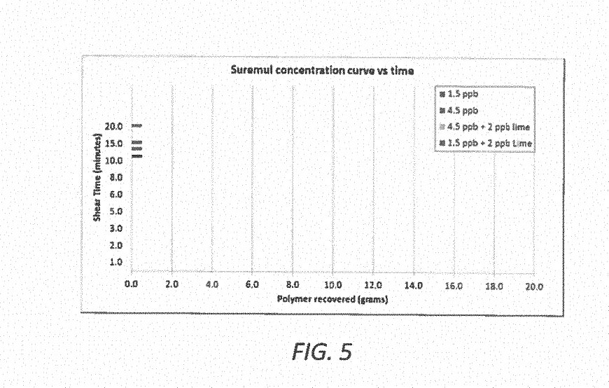

To demonstrate the role that the emulsifier has in determining the amount of polymer produced under shear multiple wellbore fluid examples formulated with various emulsifiers at various loadings were prepared. These fluids were formulated with glycerol (component 1) mixed with the brine phase, while the silicate (component 2), a sodium metasilicate, was mixed with the oleaginous phase after mixing the phases to form the emulsion. In Examples 3-6 SUREWET, distributed by M-I L.L.C., was used as an emulsifier in amounts ranging from 1.5-9 ppb. FIG. 3 shows that after 1 minute of shearing the fluids at 7000 rpm, even the fluids with the highest amounts of emulsifier produced polymer with the amount of polymer increasing as the amount of emulsifier decreased. In examples 7-9 MUL-XT, distributed by M-I L.L.C., was used as an emulsifier in amounts ranging from 4.5-12 ppb. FIG. 4 shows that after 1 minute of shearing the fluids at 7000 rpm the two fluids with the least amount of emulsifier were broken and produced polymer, while the fluid formulated with 12 ppb formed an emulsion that was strong enough to resist breaking and allowing the glycerol to react with the silicate species. In examples 10-13 SUREMUL, distributed by M-I L.L.C., was used as an emulsifier in amounts ranging from 1.5-4.5 ppb. FIG. 5 shows that even at low concentrations and when sheared for 15 minutes the emulsified fluids cannot be broken to allow the glycerol to react with the silicate species and form polymer.

### Examples 14-17

Four invert emulsion wellbore fluids were formulated according to the present disclosure to assess their stability and rheological properties. The glycerol (component 1) was mixed with the brine phase, while the silicate (component 2), sodium metasilicate, was mixed with the oleaginous phase prior to mixing and hot rolling the phases. ONE-MUL, distributed by M-I L.L.C., was used as an emulsifier for the wellbore fluid. After the fluids were formulated they were hot rolled for 16 hours at 150° C. After the hot rolling the wellbore fluids had good rheology with no sagging noticed. Table 1 provides a detailed description on the composition of the fluids and their rheological properties before and after the hot rolling process.

TABLE 1

| Product | Ex. 14 | | Ex. 15 | | Ex. 16 | | Ex. 17 | |
|---|---|---|---|---|---|---|---|---|
| DF-1 | 166 | | 166 | | 166 | | 166 | |
| ONE-MUL | 3 | | 6 | | 9 | | 12 | |
| Lime | 1.5 | | 3 | | 4 | | 6 | |
| 15% CaCl₂ | 21 | | 21 | | 21 | | 21 | |
| Glycerol | 59 | | 59 | | 59 | | 59 | |
| Barite | 188 | | 188 | | 188 | | 188 | |
| Silicate (g) | 5 | | 5 | | 5 | | 5 | |
| Rheology | BHR | AHR | BHR | AHR | BHR | AHR | BHR | AHR |
| 600 | 52 | 65 | 66 | 52 | 55 | 52 | 59 | 52 |
| 300 | 31 | 40 | 43 | 34 | 35 | 32 | 37 | 32 |
| 200 | 22 | 30 | 34 | 26 | 27 | 24 | 30 | 25 |
| 100 | 15 | 20 | 24 | 19 | 20 | 15 | 21 | 17 |
| 6 | 6 | 7 | 10 | 9 | 9 | 6 | 9 | 8 |
| 3 | 5 | 6 | 9 | 8 | 8 | 5 | 8 | 7 |
| Gel 10″ | 6 | 7 | 9 | 7 | 7 | 6 | 9 | 9 |
| Gel 10′ | 7 | 8 | 11 | 9 | 7 | 7 | 9 | 9 |
| PV | 21 | 25 | 23 | 18 | 20 | 20 | 22 | 20 |
| YP | 10 | 15 | 20 | 16 | 15 | 12 | 15 | 12 |
| ES | 600 | 800 | 700 | 800 | 600 | 800 | 600 | 800 |

Table 2 shows the result (e.g., if polymer formed or not) of shearing the fluids of Examples 14-17, respectively, with a Silverson mixer at 7000 rpm for three minutes. In each of Examples 14-17, no polymer was seen on the rotor/stator workhead indicating the emulsion is strong enough to resist breaking under these conditions.

TABLE 2

| Fluid | Polymer Formed? |
|---|---|
| Example 14 | No |
| Example 15 | No |
| Example 16 | No |
| Example 17 | No |

### Examples 18-21

To show how the loading of the silicate component may affect the stability of the emulsion, an extra 10 grams of silicate (15 g total) was added to each of the fluids of Examples 14-17 to create Examples 18-21. Table 3 shows the result (e.g., if polymer formed or not) of shearing the fluids of Examples 18-21, respectively, with a Silverson mixer at 7000 rpm for three minutes. In each of Examples 18-21, no polymer was seen on the rotor/stator workhead indicating the emulsion is strong enough to resist breaking under these conditions.

TABLE 3

| Fluid | Polymer Formed? |
|---|---|
| Example 18 | No |
| Example 19 | No |
| Example 20 | No |
| Example 21 | No |

### Examples 22-25

An extra 20 grams of silicate (25 g total) was added to each of the fluids of Examples 14-17 to create Examples 22-25. Table 4 shows the result (e.g., if polymer formed or not) of shearing the fluids of Examples 22-25, respectively, with a Silverson mixer at 7000 rpm for three minutes. In each of Examples 23-25, no polymer was seen on the rotor/stator workhead indicating the emulsion is strong enough to resist breaking under these conditions. However, Example 22, had an appreciable amount of polymer on the rotor/stator workhead indicating that the fluid with the lowest emulsifier content had broken.

TABLE 4

| Fluid | Polymer Formed? |
|---|---|
| Example 22 | Yes |
| Example 23 | No |
| Example 24 | No |
| Example 25 | No |

### Examples 26-28

An extra 40 grams of silicate (45 g total) was added to each of the fluids of Examples 15-17 to create Examples 26-28. Table 5 shows the result (e.g., if polymer formed or not) of shearing the fluids of Examples 26-28 with a Silverson mixer at 7000 rpm for three minutes. In each of Examples 26-27, a significant build-up of polymer was seen on the rotor/stator workhead indicating these emulsions are not strong enough to resist breaking under these conditions. However, Example 28 did not have polymer on the rotor/stator workhead indicating that this fluid, with the highest emulsifier content, has not yet broken.

TABLE 5

| Fluid | Polymer Formed? |
|---|---|
| Example 26 | Yes |
| Example 27 | Yes |
| Example 28 | No |

In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112(f) for any limitations of any of the claims herein, except for those in which the claim expressly uses the words ‘means for’ together with an associated function.

What is claimed is:

1. A method comprising:
drilling at least a section of a wellbore using an invert emulsion wellbore fluid comprising:
an emulsifier; and
a first wellbore strengthening material (WBS)-forming component and a second WBS-forming component; and
upon experience of a fluid loss, increasing the shear experienced at the bit.

2. The method of claim 1, further comprising resuming drilling operations after the formed WBS reduces fluid loss.

3. The method of claim 1, wherein the invert emulsion wellbore fluid has about 1.5 to 15 ppb emulsifier.

4. The method of claim 1, wherein the first WBS-forming component and the second WBS-forming component are in separate phases of the invert emulsion wellbore fluid.

5. The method of claim 1, wherein increasing the shear experienced at the bit comprises injecting a fluid through a nozzle present on a drill bit and/or drill string.

6. The method of claim 1, wherein the increase in the shear experienced at the bit is enough to break the invert emulsion wellbore fluid.

7. The method of claim 1, wherein the shear is increased to at least about 20,000 s⁻¹.

8. The method of claim 1, wherein the shear is increased to at least about 25,000 s⁻¹.

9. The method of claim 1, wherein the first WBS-forming component is one or more silicates, and the second WBS-forming component is at least one of an alcohol, polyol, amine, or polyamine.

10. The method of claim 1, wherein the formed WBS is an alcohol crosslinked silicate.

11. An invert emulsion fluid system comprising:
a continuous phase comprising a first base fluid and a first WBS-forming component; and
a discontinuous phase comprising a second base fluid and a second WBS-forming component, wherein the second WBS-forming component is capable of reacting with the first WBS-forming component to form a WBS upon breaking the invert emulsion.

12. The system of claim 11, wherein the invert emulsion fluid remains emulsified when exposed to shear below about 20,000 s⁻¹.

13. The system of claim 11, wherein the invert emulsion fluid remains emulsified when exposed to shear below about 25,000 s⁻¹.

14. The system of claim 11, wherein the first WBS-forming component is at least one of alcohol, polyol, amine, or polyamine; and the second WBS-forming component is one or more silicates.

15. The system of claim 14, wherein the first WBS-forming component is one or more silicates; and the second WBS-forming component is at least one of an alcohol, polyol, amine, or polyamine.

16. The system of claim 14, wherein the invert emulsion fluid system further comprises: at least 1.5 ppb emulsifier.

17. A method of formulating an invert emulsion fluid comprising:
mixing a first WBS-forming component with an oleaginous fluid;
mixing a second WBS-forming component with a non-oleaginous fluid; and
mixing the oleaginous fluid and non-oleaginous fluid together with an emulsifier.

18. The method of claim 17, wherein the first WBS-forming component is at least one of alcohol, polyol, amine, or polyamine; and the second WBS-forming component is one or more silicates.

19. The method of claim 17, wherein the first WBS-forming component is one or more silicates; and the second WBS-forming component is at least one of an alcohol, polyol, amine, or polyamine.

20. The method of claim 17, wherein mixing the oleaginous fluid and non-oleaginous fluid together occurs after the oleaginous fluid and the non-oleaginous fluid has been mixed with the first WBS-forming component and the second WBS-forming component, respectively.
